(19) United States
(12) Patent Application Publication
(10) Pub. No.: US 2017/0103322 A1
(43) Pub. Date: Apr. 13, 2017

(54) PROVIDING A RECOMMENDATION TO SUBSCRIBE TO A SOCIAL NETWORKING PROFILE

(71) Applicant: Google Inc., Mountain View, CA (US)

(72) Inventors: Shumeet BALUJA, Leesburg, VA (US); Michele COVELL, Palo Alto, CA (US)

(73) Assignee: Google Inc., Mountain View, CA (US)

(21) Appl. No.: 14/069,281

(22) Filed: Oct. 31, 2013

(51) Int. Cl. G06N 5/02

(52) U.S. Cl. CPC G06N 5/02

(57) ABSTRACT

Various aspects of the subject technology relate to systems, methods, and machine-readable media for recommending a profile to a user of a social network are provided. A system may be configured to retrieve subscription rate information for a first profile of a social network and subscription rate information for a second profile of the social network, calculate a similarity score based on the subscription rate information for the first profile and the subscription rate information of the second profile, and provide, to a user of the social network, a recommendation to subscribe to the first profile based on the similarity score.

### BACKGROUND

The present disclosure generally relates to providing recommendations and, in particular, to identifying entities to recommend in a social networking setting.

Entities may join social networking websites or services and create profiles in order to build communities, share information with others, and view information from others. Entities on social networking websites may include, for example, advertisers, individuals (e.g., public figures or private citizens), companies, organizations (e.g., groups, clubs, or associations), or other parties. Some entities in a social network may wish increase the number of viewers that see their activities, posts, or other published content on a social networking site. One way of increasing the number of viewers of published content related to the entity is to increase the number of other users that subscribe to or follow a profile associated with the entity.

### SUMMARY

Various aspects of the subject technology relate to a system for recommending a profile to a user of a social network. The system includes one or more processors and a machine-readable medium comprising instructions stored therein, which when executed by the one or more processors, cause the one or more processors to perform operations. The operations include retrieving subscription rate information for a first profile of a social network and subscription rate information for a second profile of the social network, calculating a similarity score based on the subscription rate information for the first profile and the subscription rate information of the second profile, and providing, to a user of the social network, a recommendation to subscribe to the first profile based on the similarity score.

Other aspects of the subject technology relate to a method for recommending a profile to a user of a social network. The method includes retrieving subscription rate information for a first profile of a social network and subscription rate information for a second profile of the social network, comparing the subscription rate information for the first profile with the subscription rate information for the second profile, calculating, using a processor, a similarity score based on the comparison, and providing, to a user of the social network, a recommendation to subscribe to the first profile based on the similarity score.

Other aspects of the subject technology relate to a non-transitory machine-readable medium comprising instructions stored therein, which when executed by a machine, cause the machine to perform operations. The operations may include identifying a group of subscribers that are subscribed to a profile of interest, selecting a target profile, wherein the at least one subscriber in the set of subscribers is also subscribed to the target profile, retrieving subscription rate information for the profile of interest and subscription rate information for the target profile, comparing the subscription rate information for the profile of interest with the subscription rate information for the target profile, and providing, to a user of the social network, a recommendation to subscribe to the profile of interest based on the comparing.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is a block diagram illustrating an example environment 100 in which recommendations to subscribe to a social networking profile may be provided to a user, in accordance with various aspects of the subject technology.

FIG. 2 is an illustration of an example user interface that includes recommendations of social networking profiles to subscribe to, according to various aspects of the subject technology.

FIG. 3 is a flow chart illustrating an example process for recommending a profile to a user of a social network, in accordance with various aspects of the subject technology.

FIG. 4 is a flow chart illustrating an example subscription rate comparison process, in accordance with various aspects of the subject technology.

FIG. 5 is a flow chart illustrating an example process for recommending a profile to a user of a social network, in accordance with various aspects of the subject technology.

FIG. 6 is a block diagram illustrating an example computer system with which any of the clients, servers, or systems described herein may be implemented, in accordance with various aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Various aspects of the subject technology relate to systems and methods for providing a user of a social network with a recommendation to subscribe to a social networking profile. A social networking profile can correspond to a user, a group or organization, an entity, an object or product, a topic, etc. According to some aspects, a system may be configured to identify a set of subscribers that are subscribed to a first profile within a social network system and determine a set of profiles that at least one subscriber in the set of subscribers are also subscribed to. For each profile in the set of profiles, the system may compare the number of subscribers from the set of subscribers that are subscribed to the profile to an expected number of users for the profile. Based on the comparing, the system may select a second profile and provide a recommendation to subscribe to the first profile to users that are subscribed to the second profile but not the first profile.

In some aspects, the system may recommend a profile to a user of a social network by retrieving subscription rate information for a first profile and a second profile in a social network and comparing the subscription rate information for the first profile with the subscription rate information of the second profile. The system may then calculate a similarity score based on the comparison and provide a recommendation to subscribe to the first profile to a user of the social network based on the similarity score.

The system may identify social networking profiles that a user is more likely to want to subscribe to using these and other aspects of the subject technology and suggest that one or more users of the social network subscribe to those social networking profiles. By providing recommendations to users to subscribe to social networking profiles, the system provides a convenient way for users to find and subscribe to profiles they may be interested in as well as a way for owners of the social networking profiles to increase their number of subscribers or follower.

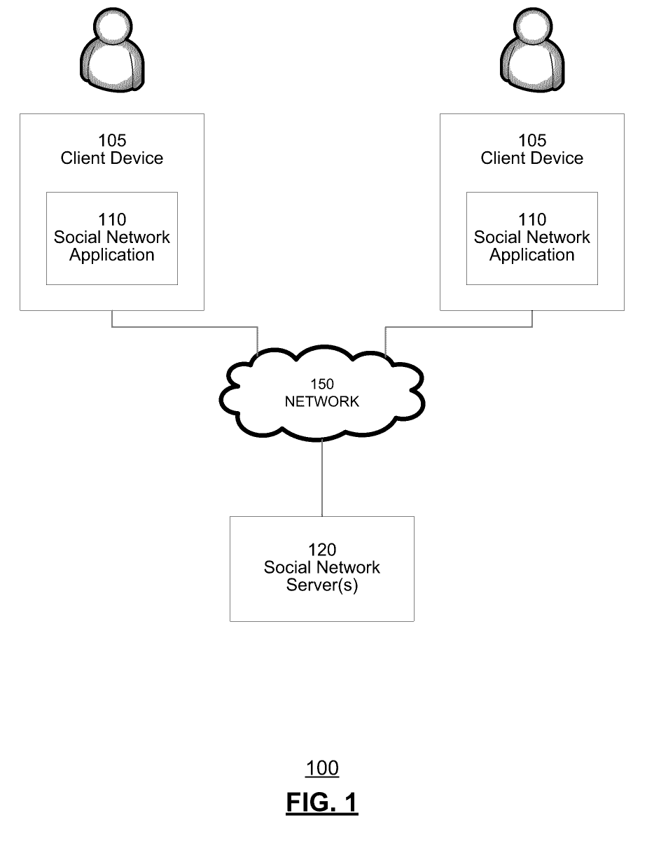

FIG. 1 is a block diagram illustrating an example environment 100 in which recommendations to subscribe to a social networking profile may be provided to a user, in accordance with various aspects of the subject technology. The network environment includes one or more client devices 105 and one or more social network servers 120 connected via a network 150 (e.g., the Internet).

The network 150 may include, for example, any one or more of a cellular network, a satellite network, a personal area network (PAN), a local area network (LAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

Each client device 105 may be any machine able to communicate with the social network servers 120 via the network 150 and receive recommendations or suggestions for social networking profiles to subscribe to. For example, client device 105 may be a desktop computer, a laptop, a mobile device (e.g., a smart phone, tablet, personal digital assistant (PDA), etc.), or any other machine with a processor, memory, and communications capabilities.

Each client device 105 may also include a social network application 110, such as a web browser or a dedicated program (e.g., an “app” for a mobile device). The social network application 110 may be configured to enable a user to interact with a social networking service hosted by the social network servers 120 and access the functionalities provided by the social networking service. For example, a social networking application 110 may enable a user to add or post content on the social network, view content from others on the social network, communicate with others on the social network, and receive recommendations or suggestions for social networking profiles to subscribe to or follow. The recommendations or suggestions may be in the form of a visual notification (e.g., a user interface element displayed on a screen of the client device 105).

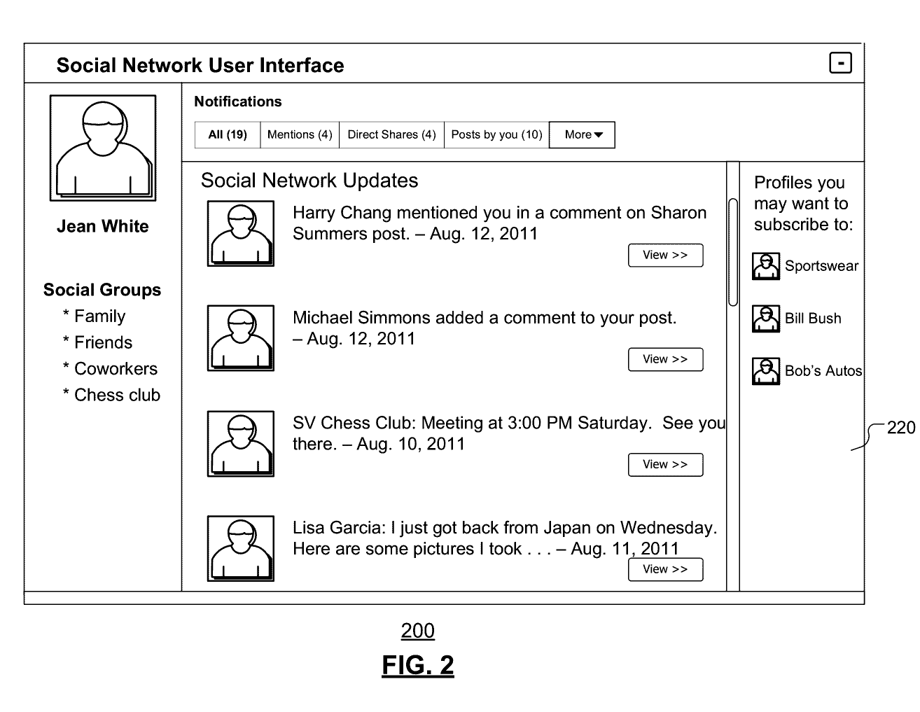

FIG. 2 is an illustration of an example user interface 200 that includes recommendations of social networking profiles to subscribe to, according to various aspects of the subject technology. The user interface 200 may be a social networking user interface provided by a social networking application 110 running on a client device 105. The user interface 200 may include a user interface component 220 that includes recommendations or suggestions for social network profiles to subscribe to. According to other aspects, the recommendations or suggestions may be provided to the user as a pop up notification on a display device for the user, provided in a message sent to the user's email account or other messaging account, or provided in some other form.

Referring back to FIG. 1, the one or more social network servers 120 may be systems or devices having a processor, a memory, and communications capability that may be used provide a platform for social network services such as posting content, viewing content, and communication between users. The one or more social networking servers 120 may also host a system configured provide users of client devices 105 with recommendations to subscribe to social networking profiles. The system may or may not be independent from the social network platform.

The system may be configured to provide recommendations by identifying which social networking profiles to recommend to a user, generating recommendations for those profiles, and transmitting those recommendations to the client devices 105. The system may identify social networking profiles for recommending to each user by calculating recommendation scores for the user for a number of profiles. The social networking profiles with the highest recommendation scores may be recommended to the user.

A user's recommendations scores for social networking profiles may be calculated based on various factors. For example, the system may consider whether or not an entity has paid for its profile to be recommended and how much the profile has paid, how popular the profile is, or shared characteristics between the user and the profile. The system may also make a determination of how likely the user will want to subscribe to the profile when calculating the recommendation score for the profile. This determination may also be based on various factors.

Various aspects of the subject technology relate to systems and methods for providing a user of a social network with a recommendation to subscribe to a social networking profile (e.g., a profile of interest) based on the profiles that the user is already subscribed to and whether those profiles that the user is already subscribed to indicate that the user may wish to subscribe to the profile of interest.

According to some aspects, a system may identify a group of subscribers of a profile of interest (e.g., users that are subscribed to the profile of interest) and find all other profiles that the group of subscribers is also subscribed to. In an illustrative scenario, the system may determine that profile A has 100 subscribers. Those subscribers may also be subscribed to a set of profiles including profiles B-G. More specifically:

40 of the subscribers in the set are also subscribed to profile B;

30 of the subscribers in the set are also subscribed to profile C;

20 of the subscribers in the set are also subscribed to profile D;

30 of the subscribers in the set are also subscribed to profile E;

10 of the subscribers in the set are also subscribed to profile F; and

25 of the subscribers in the set are also subscribed to profile G.

Although profile B has the most number of subscribers that are also subscribed to profile A, subscribing to profile B may not necessarily indicate that a user would also be interested in subscribing to profile A or that the user would be more interested in subscribing to profile A than any other profile. Instead, profile B may simply be a popular profile. Accordingly, for each profile in the set of profiles B-G, the system calculates a number of users from the set of subscribers that are subscribed to the profile and compares that number to an expected number of users for the profile.

For example, the system may determine that over the entire population of users on the social network:

56% of users subscribe to profile B;

45% of users subscribe to profile C;

10% of users subscribe to profile D;

0.5% of users subscribe to profile E;

15% of users subscribe to profile F; and

25% of users subscribe to profile G.

Accordingly, of the 100 subscribers of profile A, the expected number of subscribers of profile B is 56. The system may compare the number of subscribers in the group that are also subscribed to profile B (40) with an expected number of subscribers for profile B (56) and determine that the actual number (40) does not exceed the expected number (56). Based on the comparison, the system may identify at least one target profile. For example, the subscribers of profile A seem less interested in subscribing to profile B than compared to the average interest of the population as a whole. Therefore, subscribers of profile B are bad targets to send recommendations to subscribe to profile A.

In contrast, based on similar comparisons, subscribers of profile D and/or profile E are good targets to send recommendations to subscribe to profile A since their actual numbers exceed their expected numbers. More specifically, the expected number of subscribers of profile D for 100 members of the social network is 10 (10% of 100). However, for the 100 subscribers of profile A, there are 20 subscribers of profile D. We see that the actual number of subscribers of profile A that are also subscribers of profile D (20) exceeds the expected number of subscribers of profile D (10). Accordingly profile A is a good target to recommend to subscribers of profile D.

The expected number of subscribers of profile E for 100 members of the social network is 0.5 subscribers (0.5% of 100). However, for the 100 subscribers of profile A, there are 30 subscribers of profile E. We see that the actual number of subscribers of profile A that are also subscribers of profile E (30) exceeds the expected number of subscribers of profile E (30). Accordingly profile A is a good target to recommend to subscribers of profile E.

According to various aspects of the subject technology, once one or more target profiles (e.g., profile D and profile E) are identified for a profile of interest (e.g., profile A), the system may provide recommendations to subscribe to the profile of interest to users who are subscribed to the one or more target profiles but who are not yet subscribed to the profile of interest. According to other aspects, the system may calculate or modify the profile of interest's recommendation scores for users who are subscribed to the one or more target profiles but who are not yet subscribed to the profile of interest and provide recommendations based on those recommendation scores.

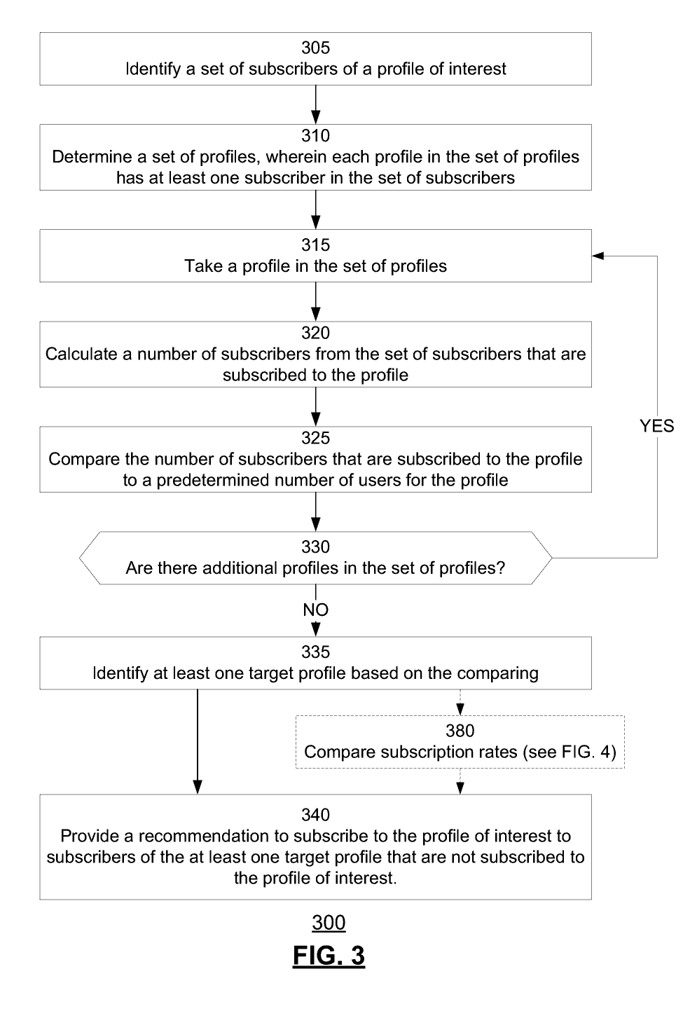

FIG. 3 is a flow chart illustrating an example process 300 for recommending a profile to a user of a social network, in accordance with various aspects of the subject technology. Although the steps in process 300 are shown in a particular order, certain steps may be performed in different orders or at the same time.

At block 305, a system may identify a set of subscribers of a profile of interest (e.g., users that are subscribed to the profile of interest). For example, the system may identify all or a subset of the subscribers of a particular profile. In the illustrative scenario introduced above, the system may identify 100 subscribers of profile A. At block 310, the system may determine a set of profiles that the set of subscribers (e.g., the 100 subscribers of profile A) are also subscribed to. The set of profiles may be all of the profiles that the set of subscribers are subscribed to or a number of the most subscribed to profiles. In the illustrative scenario, the system may determine that the 100 subscribers of profile A are also subscribed to profiles B, C, D, E, F, and G.

The system may take each profile in the set of profiles at block 315 and determine whether the actual number of subscribers of profile A that are also subscribed to each profile in the set of profiles exceeds an expected number of subscribers for that profile. For example, the system may select profile B from the set of profiles B-G and, at block 320, calculate a number of subscribers in the set of subscribers of profile A that are also subscribed to profile B. As indicated in the scenario above, 40 of the subscribers in the set of subscribers of profile A are also subscribed to profile B.

At block 325, the system may compare the number of users that are subscribed to the profile with the predetermined number of users for the profile (e.g., an expected number of users of a threshold number of users), independent of whether the subscriber is subscribed to profile A. As indicated in the scenario above, over the entire population of users of the social network, 56% of the users subscribe to profile B. Accordingly, for 100 users, the system may expect 56 subscribers of profile B. Accordingly, the system may make a comparison between the 40 out of 100 subscribers of profile A that are also subscribed to profile B with the expected number of subscribers of profile B (56).

At block 330, the system may determine whether there are additional profiles in the set of profiles that have not been processed. If there are profiles that have not been processed, the system may select the profile at block 315 and perform the calculation and comparison operations of blocks 320 and 325 as described above. Once all of the profiles in the set of profiles have been processed, at block 335, the system may identify at least one target profile based on the comparing of the actual number of subscribers for each profile and the expected number of subscribers for those profiles. In the example scenario described above, for example, profile E may be identified as a target profile. In other implementation, profile E and profile D may both be identified as target profiles.

According to some aspects, the system may identify one or more profiles that have their actual subscriber number exceed the expected number of subscribers by a predefined factor (e.g., 1.5 times, 2 times, or 5 times) as target profiles. In other variations, the actual number of subscribers of a profile must exceed the expected number of subscribers by a threshold number of subscribers (e.g., 5 subscribers, 10 subscribers, 5000 subscribers, etc.). One or more profiles may also be selected as target profiles by prioritizing the profiles (e.g., profiles B-G) that have subscribers that exceed the expected number based on how much they exceed the expected number and then selecting a number of the top profiles. The profiles may be prioritized based on, for example, the number of subscribers that exceed the expected number or the ratio of actual subscribers to expected number of subscribers.

At block 340, the system may provide a recommendation to subscribe to the profile of interest (e.g., profile A) to subscribers of an identified target profile if the subscribers of the target profile are not already subscribed to the profile of interest. For example, if profile D is identified as a target profile, the subscribers of profile D that are not subscribers of the profile of interest (e.g., profile A) may be provided with a recommendation suggesting that they subscribe to profile A. The recommendation may be in the form of a post in a user's social network stream, an email addressed to the user, or another recommendation notification.

As described above, one or more profiles may be identified as target profiles (e.g., profile E and profile D may both be target profiles). However, according to other aspects of the subject technology, a combination of profiles may also be identified as a “target profile.” For example, a combination of profile E and profile D may be identified as a target profile. As a result, the system may transmit recommendations to users who are subscribed to both profile E and profile D, who are not subscribed to the profile of interest (e.g., profile A).

The combination of profiles that are identified by the system as a target profile may include 2 or more profiles from the set of profiles. Furthermore, the combination of profiles may be identified based on the comparison between the actual number of subscribers and the expected number of subscribers for reach of the individual profiles in the combination of profiles. For example, the combination may include two or more of the profiles with that exceed their expected number of subscribers the most or by the biggest factor. In another variation, a number of the profiles that exceed their expected number of subscribers by a threshold amount may be included in a combination.

According to other aspects of the subject technology, the system may be configured to generate combinations of profiles based on the set of profiles, calculate the number of users in the set of subscribers of the profile of interest (e.g., profile A) that are also subscribed to each combination of profiles, and calculate an expected number of subscribers for each combination of profiles. The system may then compare the actual number of subscribers for each combination of profiles with the expected number of subscribers for the combination of profiles and identify one or more of the generated combinations as a target profile based on the comparing.

In the example described above, the expected number of subscribers for profile B was calculated based on an expected percentage of users over the entire population of users of the social network. However, according to other aspects of the subject technology, the expected number of subscribers may be calculated based on different populations. For example, the system may limit or filter the entire population of users using various demographics or other user characteristics. For example, the population used to calculated the expected number of subscribers for a profile may be limited to a particular geographic location (e.g., users who live in the United States, Vermont, etc.), a particular age group (e.g., 18-24 years old, 25-35 years old, etc.), users of a particular gender, or other user characteristics (e.g., users that are online for more than 3 hours a day, users with over 10 picture in their profile, users that speak a particular language, etc.).

The characteristics used to limit or filter the population used to calculate the expected number of subscribers may also be used in determining which users are to be provided recommendations. For example, if the expected number of subscribers for a profile is calculated based on the population of social networking users between the ages of 18-25, subscribers of a target profile between the ages of 18-25 that are not subscribed to a profile of interest may be provided recommendations to subscribe to the profile of interest.

According to some aspects of the subject technology, the system may provide a user with the recommendation to subscribe to a profile in a social network based on a number of recommendation scores for profiles in the social network. For example, each user may have multiple recommendation scores for different profiles in the social network, and the system may provide a recommendation to at least one of the target profiles based on their respective recommendation scores (e.g., recommendations may be provided for the target profiles with the highest recommendations scores).

When the user is subscribed to one or more of the target profiles for a profile of interest, the system may calculate or modify the user's recommendation score for that profile to increase the recommendation score. The recommendation score may be increased by a certain amount based on, for example, how much the actual number of subscribers for a target profile that the user is subscribed to exceeds the expected number of subscribers (e.g., if the user is subscribed to profile D, how much does the actual number of subscribers to D exceed the expected number of subscribers to D) or the number of target profiles for the profile of interest that the user is subscribed to (e.g., whether, in the illustrative scenario described above, the user is subscribed to only one or both of the target profiles D and E).

According to various aspects of the subject technology, a user's recommendation score for a profile may be further calculated or modified based on a comparison between the subscription rates of a target profile and a profile of interest. Certain types of profiles tend to have characteristic subscription rates (e.g., how quickly the profile gains or loses subscribers over time and across geographic locations). For example, a movie premier profile may see a large country-wide spike in subscriptions around the premier date then a rapid slowing of the increase of subscriptions, eventually leading to a gradual decline of subscriptions. A restaurant profile may see a gradual, geographically-localized, increase of followers with intermittent additions of subscriptions corresponding to when news stories about the restaurant or reviews about the restaurant are published.

Finding profiles with similar subscription rates may indicate that the profiles are of similar types or may otherwise have similarities. By comparing the subscription rates of a target profile and a profile of interest, the system may determine whether the target profile and the profile of interest are similar types of profiles. If the profiles are of similar types, the target profile may be more appropriate to recommend to subscribers of the profile of interest. Accordingly, the system may increase the recommendation score of the target profile for subscribers of the profile of interest.

For example, referring back to block 335 of FIG. 3, the system may identify a target profile for a profile of interest. According to some aspects of the subject technology, after target profile is identified, the system may perform a subscription rate comparison process at block 380 that compares the subscription rate of the profile of interest to the subscription rate of the identified target profile.

The comparisons are then taken into consideration when recommendations to subscribe to the profile of interest are provided to subscribers of the one or more target profiles at block 340. For example, a user's recommendation score for the profile of interest may be increased more if the user is subscribed to a target profile that has a similar subscription rate as the profile of interest. On the other hand, if the user is subscribed to a target profile that has a subscription rate that is very different than the subscription rate for the profile of interest, the user's recommendation score for the profile of interest may remain unchanged, be decreased, or be increased by an amount less than if the subscription rates were similar.

For example, in the illustrative scenario discussed above, the system may compare the subscription rate of profile A, the profile of interest, to the subscription rate of profile D, the target profile, for a period of time (e.g., 30 days). The period of time may be the exact same time period for both profile A and profile D (e.g., the previous 30 days, 30 days after Memorial Day, June 2013, etc.) or relative time periods (e.g., the 30 days after each profile's first post, the 30 days after each profile's creation, the 15 days before and 15 days after a specific event for each profile, etc.).

The system may compare, for each segment (e.g., day) in the period of time, the number of subscribers of profile A to the number of subscribers of profile D. In other variations, the system may compare the percentage change from one segment in the period of time to the next for each profile. The data may be inputted into a dependent t-test for paired samples, a Fréchet distance test, or any other appropriate comparison test in order to arrive at a similarity score. The system may then calculate or modify the recommendation score of the profile of interest for subscribers of the target profile based on the similarity score.

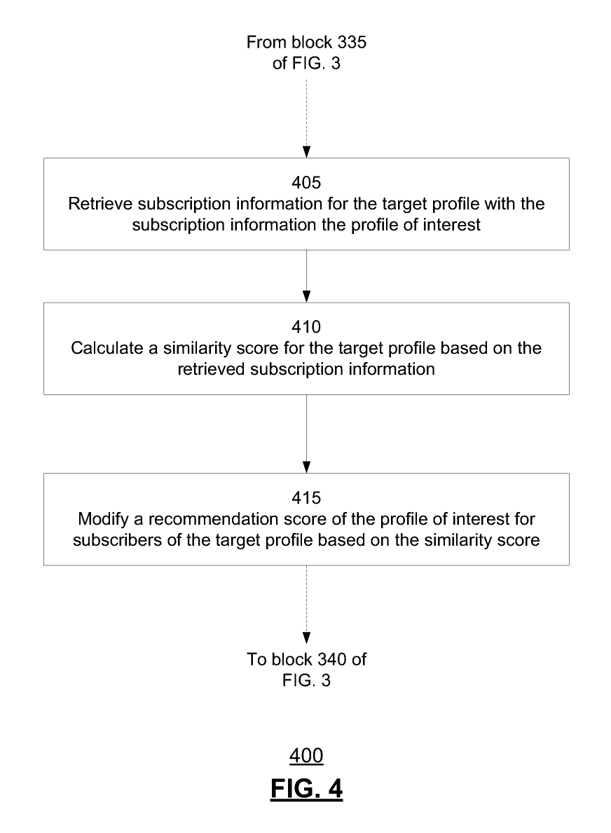

FIG. 4 is a flow chart illustrating an example subscription rate comparison process 400, in accordance with various aspects of the subject technology. Although the steps in process 400 are shown in a particular order, certain steps may be performed in different orders or at the same time.

After the system identifies a target profile for a profile of interest (e.g., at block 335 of FIG. 3), at block 405 the system may retrieve subscription information for the target profile and subscription information for the profile of interest. The subscription information for the profiles may be stored in a database on one or more of the social network servers 120 of FIG. 1 or on another server.

At block 410, the system calculates, based on the retrieved subscription information, a similarity score for the target profile that represents how similar the subscription rate for the target profile is to the subscription rate for the profile of interest. For example, the system may compare subscription information for both profiles for one or more periods of time. Each period of time may be the same period (e.g., the past 6 months) of time or different relative periods of time (the first 3 months after the profile joined the social networking service). The system may divide the period of time into a number of segments (e.g., hours, days, weeks, or months) and compare the number of subscribers that each profile has for each of those time segments.

According to some aspects of the subject technology, the system may use the number of subscribers for the target profile for each segment in the period of time and the number of subscribers for the profile of interest for each segment in the period of time as input into an algorithm that calculates how different two sets of data are from each other. As an illustrative example, a target profile has the following number of subscribers for a time period of a week, which had been divided into segments of 1 day each:

5 followers on day 1;

18 followers on day 2;

37 followers on day 3;

86 followers on day 4;

102 followers on day 5;

110 followers on day 6; and

105 followers on day 7.

On the other hand, a profile of interest, for the same time period of 7 days has the following number of subscribers:

9 followers on day 1;

27 followers on day 2;

38 followers on day 3;

45 followers on day 4;

96 followers on day 5;

116 followers on day 6; and

124 followers on day 7.

The number of followers for each day in the week-long time period for the profile of interest and the target profile may be inputted into a dependent t-test for paired samples. The outputted value from the dependent t-test may be used as the similarity score for the target profile or used as a factor in determining the similarity score for the target profile.

In another variation, the system may use the change in the number or percent of subscribers from one time segment to the next as input into an algorithm that calculates how different two sets of data are from each other. As an illustrative example, the following information may be used as input for the target profile for a time period of 6 week, which had been divided into segments of 1 week each:

134% change in the number of subscribers from week 1 to week 2;

212% change in the number of subscribers from week 2 to week 3;

187% change in the number of subscribers from week 3 to week 4;

143% change in the number of subscribers from week 4 to week 5; and

95% change in the number of subscribers from week 5 to week 6.

On the other hand, a profile of interest, for the same time period of 6 has the following subscriber information:

128% change in the number of subscribers from week 1 to week 2;

195% change in the number of subscribers from week 2 to week 3;

179% change in the number of subscribers from week 3 to week 4;

147% change in the number of subscribers from week 4 to week 5; and

103% change in the number of subscribers from week 5 to week 6.

The percent change in the number of subscribers from each week to the next during the 6-week long time period may be used as input in calculating the Fréchet distance between the two data sets. The Fréchet distance may then be used as the similarity score for the target profile or used as a factor in determining the similarity score for the target profile. According to other aspects of the subject technology, other methods (or combinations of methods) of calculating the differences and similarities between two data sets may also be used to arrive at a similarity score.

Furthermore, the subscription information may be limited to particular geographic locations the subscription information used to generate a similarity score may be a subset of all the subscription information available for each profile. For example, the subscription information for a profile may be limited to subscribers located in a particular geographic location (e.g., users who live in the United States, California, in the home city or state of the profile, etc.), subscribers that belong to a particular age group (e.g., 18-24 years old, 25-35 years old, etc.), subscribers of a particular gender, or subscribers that belong to another defined population.

After the similarity score for the target profile is calculated, at block 415, the system may then calculate or modify the recommendation score of the profile of interest for subscribers of the target profile based on the similarity score. For example, if the similarity score for the target profile indicates that the target profile and the profile of interest are similar, the system may increase the recommendation score of the profile of interest for users that are subscribed to the target profile, but not subscribed to the profile of interest. The process may then proceed to block 340 of FIG. 3, where the system may provide a recommendation to subscribe to the profile of interest to subscribers of the target profile that are not already subscribed to the profile of interest based on the recommendation score for the profile of interest.

Although the process 400 of comparing subscription rates is described above and in FIG. 4 as taking place after the comparing of the actual number of subscribers to the expected number of subscribers, according to other aspects, the comparing of subscription rates may occur before or in parallel with the comparing of the actual number of subscribers to the expected number of subscribers or the other steps shown in FIG. 3.

According to some aspects, the system may calculate two separate scores that may be used in calculating an overall recommendation score for a profile of interest. For example the system may calculate a first score based on comparing the actual number of subscribers in the set of subscribers for the profile of interest that are also subscribed to the target profile to the expected number of subscribers for the target profile. The system may also calculate a second score (e.g., a similarity score) based on comparing subscriber rate information of the target profile with the subscriber rate information for the profile of interest. The two scores may be averaged together to come up with the overall recommendation score for the profile of interest or may otherwise be used in a formula to calculate the overall recommendation score.

According to other aspects, the similarity score may be used to filter out potential recommendations. For example, if the similarity score for the target profile is below a threshold score, the system will not recommend the profile of interest to subscribers of the target profile regardless of the overall recommendation score.

According to various aspects of the subject technology, the comparing of subscription rates for profiles and providing recommendations to users based on the comparisons may happen independently from the process 300 shown in FIG. 3. More specifically, various aspects of the subject technology relate to systems and methods for providing a user of a social network with a recommendation to subscribe to a social networking profile based on comparing subscription rates of a target profile and a profile of interest. By comparing the subscription rates of the profiles, the system may determine whether the target profile and the profile of interest are similar types of profiles. If the profiles are of similar types, the target profile may be more appropriate to recommend to subscribers of the profile of interest.

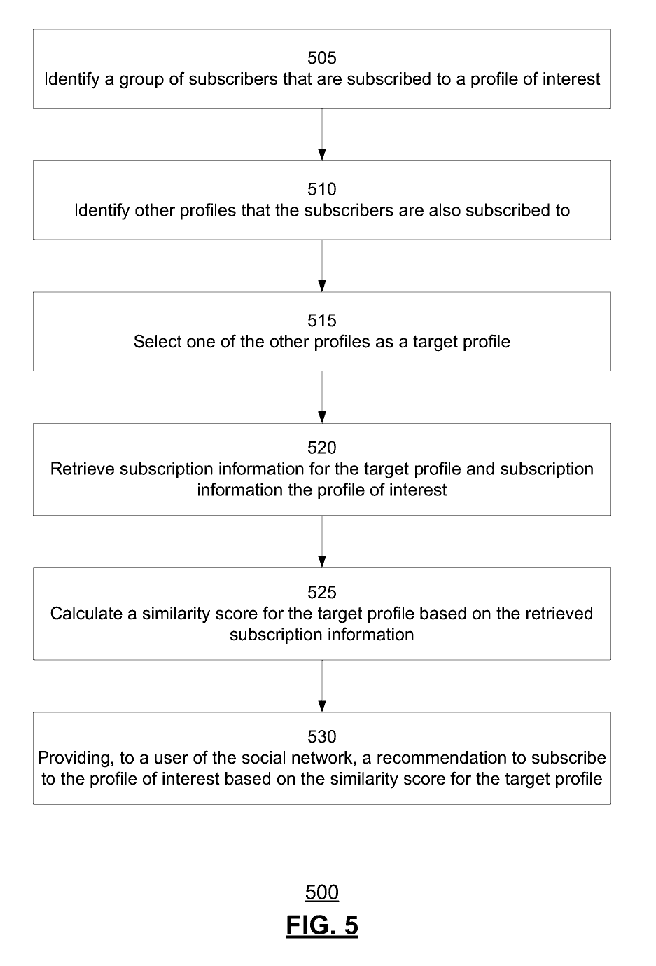

FIG. 5 is a flow chart illustrating an example process 500 for recommending a profile to a user of a social network, in accordance with various aspects of the subject technology. Although the steps in process 500 are shown in a particular order, certain steps may be performed in different orders or at the same time. Furthermore, the process may be performed by a system which may be hosted on one or more servers, such as the social network servers 120 in FIG. 1.

At block 505, the system may identify a group of subscribers of a profile of interest (e.g., all users that are subscribed to the profile of interest) and, at block 510, identify other profiles that the subscribers are also subscribed to. For example, the system may identify a group of 100 subscribers of profile A, the profile of interest, and at least some of those subscribers may also subscribe to other profiles (e.g., profiles B, C, D, E, F, and G). These other profiles are potential target profiles.

In some cases, the number of profiles that are also subscribed to may be quite large. Accordingly, at block 515, the system may select one of the profiles as a target profile that may be compared to the profile of interest. For example, the system may determine the how many subscribers in the group of subscribers of the profile of interest are also subscribed to each of the potential target profiles and select the profile with the most subscribers as the target profile. In other variations, multiple profiles (e.g., the top 5, the top 20%, or all of the identified profiles) may be selected as target profiles and compared to the profile of interest. In other aspects of the subject technology, the system may select target profiles based on other factors as well.

For each target profile selected, the system may compare the subscription rate for the target profile with the subscription rate of the profile of interest. For example, retrieving subscription information for the target profile and subscription information for the profile of interest from a data store (e.g., a database or from a remote server) at operation 515. Subscription information may include a history or log of subscriber activity for a profile. For example, the subscription information may include a log of when a user has subscribed to the profile or unsubscribed to a profile or any other information that may be used to determine the number of subscribers a profile has at any given moment. The subscription information may also be organized based on time increments or segments (e.g., minutes, hours, days, weeks, etc.) and show the number of subscribers that the profile has during those time increments. The subscription information may also include anonymized information about the group of subscribers of a profile such as age, location, gender, user profile information, or other demographic information.

At block 525, the system may use the subscription information for the target profile and the profile of interest to calculate a similarity score for the target profile. As described above, the system may input subscription information for both profiles in a comparison algorithm. Some example comparison algorithms may include a dependent t-test for paired samples, a Fréchet distance test, or any other appropriate comparison test in order to arrive at a similarity score. In other variations, the system may input the percentage change from one day to the next for each profile into the comparison algorithm.

According to some aspects of the subject technology, the system may be configured to calculate multiple similarity scores between the target profile and the profile of interest. Each similarity score may be calculated based on a certain aspect or subset of the subscription information for the profiles. According to some aspects, similarity scores may be calculated for different geographic regions based on subscription information of subscribers located in the different geographic regions (e.g., zip codes, cities, states, or country regions, or countries, or world regions). The geographic regions that are used may be selected by an administrator.

For example, a similarity score for the target profile may be calculated for geographic region X using subscription information for subscribers of the target profile and/or the profile of interest that are located in region X. Other similarity scores may be calculated for other regions as well. Additionally, a similarity score may be calculated for a home region (e.g., a home city, state, or country) based on subscription information for subscribers of the target profile located in a home region for the target profile (e.g., the physical location of the target profile) and subscription information for subscribers of the profile of interest located in a home region for the profile of interest.

According to other aspects of the subject technology, similarity scores may be calculated based on other characteristics as well. The characteristics may include, for example, subscribers that belong to a particular age group (e.g., 18-24 years old, 25-35 years old, etc.), subscribers of a particular gender, subscribers that have been active on the social network recently (e.g., in the past 2 weeks), or subscribers that belong to another defined population.

The different similarity scores may be added or averaged together to generate an overall similarity score for the target profile. In other aspects, the similarity scores may be input into an algorithm that computes an overall similarity score in which each similarity score may be weighted non-uniformly based on other factors. The factors may include, for example, the population of a geographic region, the population density of a geographic region, the size of a geographic region, the number of subscribers that correspond with one or more characteristics, or any other factor.

After an overall similarity score is calculated, at block 530, the system may use the similarity score for the target profile to provide a user of the social network with a recommendation to subscribe to the profile of interest. For example, if the similarity score for a target profile indicates that the subscription rate for the target profile is similar to the subscription rate for the profile of interest, the system may be more likely to provide subscribers of the target profile that are not subscribed to the profile of interest with recommendations to subscribe to the profile of interest. On the other hand, if the similarity score for a target profile indicates that the subscription rate for the target profile is not similar to the subscription rate for the profile of interest, the system may be less likely to provide subscribers of the target profile that are not subscribed to the profile of interest with recommendations to subscribe to the profile of interest.

As mentioned above, according to some aspects of the subject technology, recommendations for users to subscribe to a profile may be provided based on a number of recommendation scores that a user a user has for profiles in the social network. The social networking profiles with the highest recommendation scores may be recommended to the user or recommended to the user before other profiles.

A user's recommendations scores for social networking profiles may be calculated based on various factors including the similarity score between a profile and another profile that the user is a subscriber for. For example, the recommendation score for a profile may be may be greater (e.g., the system may be more likely to recommend the profile and/or recommend the profile before other profiles) if the similarity score for the target profile that the user is already subscribed to indicates a strong similarity to the profile of interest. In contrast, the recommendation score for a profile may be may be less (e.g., the system may be less likely to recommend the target profile) if the similarity score for the target profile that the user is subscribed to indicates a weaker similarity to the profile of interest.

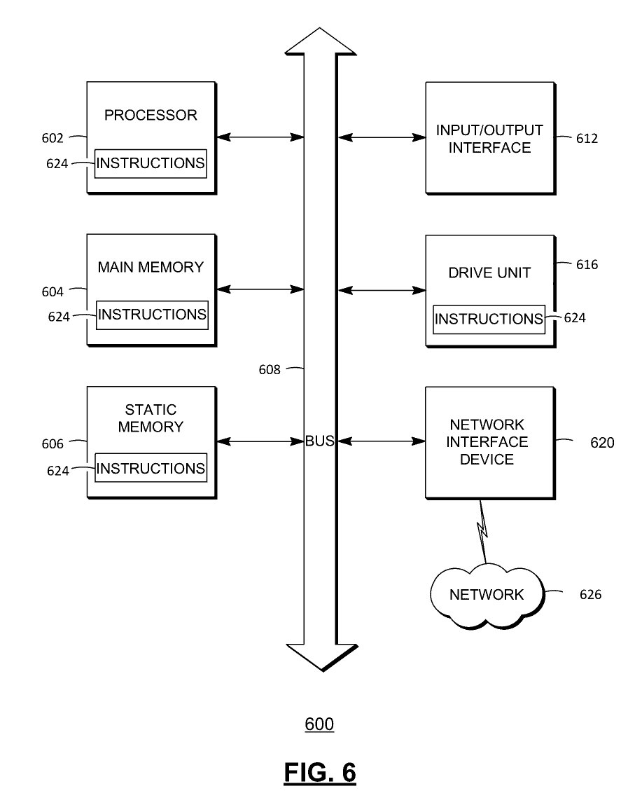

FIG. 6 is a block diagram illustrating an example computer system with which any of the clients, servers, or systems described herein may be implemented, in accordance with various aspects of the subject technology. In certain aspects, the computer system 600 may be implemented using hardware or a combination of software and hardware, either in a dedicated server, or integrated into another entity, or distributed across multiple entities.

The example computer system 600 includes a processor 602, a main memory 604, a static memory 606, a disk drive unit 616, and a network interface device 620 which communicate with each other via a bus 608. The computer system 600 may further include an input/output interface 612 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 602 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 624 embodying any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media. The instructions 624 may further be transmitted or received over a network 626 via the network interface device 620.

The machine-readable medium may be a single medium or multiple media (e.g., a centralized or distributed database, and/or associated caches and servers) that store the one or more sets of instructions. The machine-readable medium may comprise the drive unit 616, the static memory 606, the main memory 604, the processor 602, an external memory connected to the input/output interface 612, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as preferred or advantageous over other aspects or designs.

1. A method for recommending a profile to a user of a social network, the method comprising:
retrieving subscription rate information for a first profile of a social network and subscription rate information for a second profile of the social network,
wherein the subscription rate information for the first profile comprises a respective rate of change in a number of subscribers for the first profile for each time segment in a first period of time relative to a first event,
wherein the subscription rate information for the second profile comprises a respective rate of change in a number of subscribers for the second profile for each time segment in a second period of time relative to a second event different than the first event, and
wherein the first period of time and the second period of time are different time periods relative to the first event and the second event, respectively, and wherein the first period of time and the second period of time are of equal length;
comparing the subscription rate information for the first profile with the subscription rate information for the second profile;
calculating, using a processor, a similarity score based on the comparison of the subscription rate information for the first profile with the subscription rate information for the second profile; and
providing, to a user of the social network, a recommendation to subscribe to the first profile based on the similarity score.

2. The method of claim 1, further comprising:
identifying a group of subscribers that are subscribed to the first profile;
determining a set of profiles, wherein each profile in the set of profiles has at least one subscriber in the group of subscribers subscribed to the first profile; and
selecting the second profile from the set of profiles.

3. The method of claim 2, further comprising:
calculating a number of subscribers from the set of subscribers that are subscribed to each of the profiles in the set of profiles,
wherein the second profile is selected based on the number of users that are subscribed to the profiles in the set of profiles.

4. (canceled)

5. The method of claim 1, wherein the subscription rate information further comprises a measure of a change in a number of subscribers for a profile for each transition from one time segment to a next time segment in a period of time.

6. The method of claim 1, wherein the similarity score is calculated using a dependent t-test.

7. The method of claim 1, wherein the similarity score is calculated using a Fréchet distance test.

8. The method of claim 1, further comprising:
calculating a recommendation score for the first profile based on the similarity score,
wherein the providing of the recommendation to subscribe to the first profile is based on the recommendation score.

9. The method of claim 1, wherein the subscription rate information for the first profile and the subscription rate information for the second profile correspond to subscribers in a particular location or of a particular age group.

10. The method of claim 1, further comprising:
identifying a set of subscribers of the first profile;
calculating a number of subscribers from the set of subscribers that are subscribed to the second profile; and
comparing the number of subscribers that are subscribed to the second profile to an expected number of subscribers for the second profile,
wherein the providing of the recommendation to subscribe to the first profile is further based on the comparing of the number of subscribers to the expected number of subscribers.

11. A system for recommending a profile to a user of a social network, the system comprising:
one or more processors; and
a machine-readable medium comprising instructions stored therein, which when executed by the one or more processors, cause the one or more processors to perform operations comprising:
retrieving subscription rate information for a first profile of a social network and subscription rate information for a second profile of the social network,
wherein the subscription rate information for the first profile comprises a respective rate of change in a number of subscribers for the first profile for each time segment in a first period of time relative to a first event,
wherein the subscription rate information for the second profile comprises a respective rate of change in a number of subscribers for the second profile for each time segment in a second period of time relative to a second event different than the first event, and
wherein the first period of time and the second period of time are different time periods relative to the first event and the second event, respectively, and wherein the first period of time and the second period of time are of equal length;
calculating a similarity score based on a comparison of the subscription rate information for the first profile and the subscription rate information of the second profile; and
providing, to a user of the social network, a recommendation to subscribe to the first profile based on the similarity score.

12. The system of claim 11, wherein the operations further comprise:
identifying a group of subscribers that are subscribed to the first profile;
determining a set of profiles, wherein each profile in the set of profiles has at least one subscriber in the group of subscribers subscribed to the first profile; and
selecting the second profile from the set of profiles.

13. The system of claim 12, wherein the operations further comprise:
calculating a number of subscribers from the set of subscribers that are subscribed to each of the profiles in the set of profiles,
wherein the second profile is selected based on the number of users that are subscribed to the profiles in the set of profiles.

14. The system of claim 11, wherein the operations further comprise:
calculating a recommendation score for the first profile based on the similarity score,
wherein the providing of the recommendation to subscribe to the first profile is based on the recommendation score.

15. The system of claim 11, wherein the operations further comprise:
identifying a set of subscribers of the first profile;
calculating a number of subscribers from the set of subscribers that are subscribed to the second profile; and
comparing the number of subscribers that are subscribed to the second profile to an expected number of subscribers for the second profile,
wherein the providing of the recommendation to subscribe to the first profile is further based on the comparing of the number of subscribers to the expected number of sub scribers.

16. The system of claim 11, wherein the recommendation to subscribe to the first profile is provided in an email.

17. A non-transitory machine-readable medium comprising instructions stored therein, which when executed by a machine, cause the machine to perform operations comprising:
identifying a group of subscribers that are subscribed to a profile of interest of a social network;
selecting a target profile, wherein the at least one subscriber in the group of subscribers is also subscribed to the target profile;
retrieving subscription rate information for the profile of interest and subscription rate information for the target profile,
wherein the subscription rate information for the profile of interest comprises a respective rate of change in a number of subscribers for the profile of interest for each time segment in a first period of time relative to a first event,
wherein the subscription rate information for the target profile comprises a respective rate of change in a number of subscribers for the target profile for each time segment in a second period of time relative to a second event different than the first event, and
wherein the first period of time and the second period of time are different time periods relative to the first event and the second event, respectively, and wherein the first period of time and the second period of time are of equal length;
comparing the subscription rate information for the profile of interest with the subscription rate information for the target profile;
calculating a similarity value based on the comparison of the subscription rate information for the profile of interest with the subscription rate information for the target profile; and
providing, to a user of the social network, a recommendation to subscribe to the profile of interest based on the similarity value.

18. (canceled)

19. The non-transitory machine-readable medium of claim 17, wherein the operations further comprise:
identifying a set of subscribers of the profile of interest;
calculating a number of subscribers from the set of subscribers that are subscribed to the target profile;
comparing the number of subscribers that are subscribed to the target profile to an expected number of subscribers for the target profile; and
calculating a second value based on the comparing of the number of subscribers that are subscribed to the target profile to the expected number of subscribers for the target profile,
wherein the providing of the recommendation to subscribe to the profile of interest is further based on the second value.

20. The non-transitory machine-readable medium of claim 19, wherein the operations further comprise:
determining that the user is subscribed to the target profile;
calculating, based on the similarity value and the second value, a recommendation score for the user, the recommendation score corresponding to the profile of interest;
wherein the providing of the recommendation to subscribe to the profile of interest is based on the recommendation score.
